(19) United States
(12) Patent Application Publication
(10) Pub. No.: US 2014/0297887 A1
(43) Pub. Date: Oct. 2, 2014

(54) METHOD FOR TRANSMITTING INFORMATION ON PRIORITY BASIS TO ONE OR MORE NODES IN DISTRIBUTED NETWORK

(71) Applicant: WHISTLE TALK TECHNOLOGIES PVT. LTD., Bangalore (IN)

(72) Inventors: Ajay Kumar NEMA, Bangalore (IN); Manish Kumar NEMA, District - Sagar (IN); Mohan Kumar PANDIAN, Kovilpatti (IN); Roopesh Kumar NEMA, Sagar (IN); Saravanan SOUPRAMANIANE, Villianur (IN); Siva Kiran DHULIPALA, Bangalore (IN); Vinoo M. CHACKO, Thiruvananthapuram (IN)

(73) Assignee: WHISTLE TALK TECHNOLOGIES PVT. LTD., Bangalore (IN)

(21) Appl. No.: 14/242,158

(22) Filed: Apr. 1, 2014

(30) Foreign Application Priority Data
Apr. 1, 2013 (IN) 4115/CHE/2012

(51) Int. Cl. H04L 12/701

(52) U.S. Cl. CPC H04L 45/00
USPC 709/240

(57) ABSTRACT

The present disclosure is related to a method for transmitting information on priority basis to one or more nodes in distributed network. The routing server at source node generates one or more set of nodes from plurality of nodes based on reputation value. The routing server identifies first set of nodes with highest reputation value, determines predicted action to be perforrmed by each node. The routing server transmits information to each node in first set. Each node performs an action. The routing server computes the difference between the predicted action and action performed by each node in the first set and updates the reputation value of each node in the first set. Thereafter, routing server transmits the information the second set, third set and so on.

### TECHNICAL FIELD

The present disclosure relates to distributed network technologies. In particular, the present disclosure relates to a method for transmitting information on priority basis to one or more nodes in a distributed network.

### BACKGROUND

A distributed network is a network structure in which each node is connected to one or more nodes through one or more links. The one or more links between the nodes is at least one of relationships in social networks, entries in an address book, wired or wireless. The one or more Nodes may include, but not limited to, people in social network, entries in address book, hosts such as personal computers, phones, servers and any other networking hardware device.

One important emerging class of problems in the distributed network involves identifying one or more nodes in the network which has full or partial answer to the request/information provided by the source node i.e finding one or more target nodes in the network for the given information. For the given information, there may be n number of nodes in the network which has partial or full answer to the request. But out of those n numbers of nodes, it is a complex task to identify potential nodes for which the first priority has to be given to access the information from the source node, thereby providing a greater advantage for the potential nodes. Considering an example of an employment opportunity, a task of finding a suitable employee amongst a potentially huge number of applicants obtained through public advertising can be a significant task for many employers. The applicants who gain priority access to the information of a new job opening have greater advantage. These applicants could apply for the new opening early compared to the other people who are in the same domain area, take more time to research about the company and the job opportunity, gain more time to prepare for the interviews. Hence, it is very important to provide access to information to those people first who have greater privilege than others so that they get more advantage than other for the job opportunity.

Therefore, there exists a need for a method for transmitting information on priority basis to one or more nodes in a distributed network.

### SUMMARY

The shortcomings of the prior art are overcome and additional advantages are provided through the present disclosure. Additional features and advantages are realized through the techniques of the present disclosure. Other embodiments and aspects of the disclosure are described in detail herein and are considered a part of the claimed disclosure.

The present disclosure provides a method for transmitting information on priority basis to one or more nodes in the distributed network. The method comprises generating, at a routing server, one or more set of nodes from a plurality of nodes in the distributed network based on a reputation value associated with each of the one or more nodes. The routing server identifies a first set of nodes from the one or more set of nodes, wherein each node in the first set has a reputation value which is higher than the reputation value of each node in other sets. The routing server determines a predicted action to be performed by each node in the first set and thereafter transmits information on a priority basis to each node in the first set. The routing server receives data from each node of the first set, wherein the data is associated with an action performed by each node in the first set. The routing server determines the delta value between the predicted action and the action performed by each node in the first set and updates the reputation value associated with each node based on the delta value determined for each node.

The present disclosure provides a routing server for transmitting information on a priority basis to one or more nodes in the distributed network. The routing server comprises at least one processor and a memory storing instructions executable by the at least one processor, wherein the instructions configure the at least one processor to generate one or more set of nodes from a plurality of nodes in the distributed network based on the reputation value associated with each of the one or more nodes, identify a first set of nodes from the one or more set of nodes, wherein each node in the first set is having a reputation value higher than the reputation value of each node in other sets, determine a predicted action to be performed by each node in the first set and transmitting information on a priority basis to each node in the first set which has reputation value which is higher than the reputation value of each node in the other set, receive data from each node of the first set, wherein the data is associated with an action performed by each node in the first set, determine the delta score between the predicted action and the action performed by each node in the first set and update the reputation value associated with each node based on the delta score determined for each node.

The foregoing summary is illustrative only and is not intended to be in any way limiting. In addition to the illustrative aspects and features described above, further aspects, and features will become apparent by reference to the drawings and the following detailed description.

### BRIEF DESCRIPTION OF THE DRAWINGS

The novel features and characteristics of the disclosure are set forth in the appended claims. The embodiments of the disclosure itself, however, as well as a preferred mode of use, further objectives and advantages thereof, will best be understood by reference to the following detailed description of an illustrative embodiment when read in conjunction with the accompanying drawings. One or more embodiments are now described, by way of example only, with reference to the accompanying drawings in which:

FIG. 1 illustrates an exemplary environment for transmitting information on priority basis to one or more nodes in the network in accordance with some embodiments of the present disclosure;

FIG. 2 illustrates a block diagram of a routing server in accordance with some embodiments of the present disclosure;

FIG. 3a and FIG. 3b illustrate an exemplary process for transmitting information on a priority basis to one or more nodes in the network accordance with some embodiment of the present disclosure; and

FIG. 4 shows a flowchart illustrating a method for transmitting information on priority basis to one or more nodes in the network in accordance with some embodiments of the present disclosure.

The figures depict embodiments of the disclosure for purposes of illustration only. One skilled in the art will readily recognize from the following description that alternative embodiments of the structures and methods illustrated herein may be employed without departing from the principles of the disclosure described herein.

### DETAILED DESCRIPTION

The foregoing has broadly outlined the features and technical advantages of the present disclosure in order that the detailed description of the disclosure that follows may be better understood. Additional features and advantages of the disclosure will be described hereinafter which form the subject of the claims of the disclosure. It should be appreciated by those skilled in the art that the conception and specific aspect disclosed may be readily utilized as a basis for modifying or designing other structures for carrying out the same purposes of the present disclosure. It should also be realized by those skilled in the art that such equivalent constructions do not depart from the spirit and scope of the disclosure as set forth in the appended claims. The novel features which are believed to be characteristic of the disclosure, both as to its organization and method of operation, together with further objects and advantages will be better understood from the following description when considered in connection with the accompanying figures. It is to be expressly understood, however, that each of the figures is provided for the purpose of illustration and description only and is not intended as a definition of the limits of the present disclosure.

In an embodiment, the present disclosure provides a method for transmitting information on a priority basis to one or more nodes in the distributed network. The routing server at the source node identifies one or more nodes in the network based on the information. Thereafter, the routing server generates one or more set of nodes from a plurality of nodes in the distributed network based on a reputation value associated with each of the one or more nodes. Upon generating one or more set of nodes, the routing server identifies a first set of nodes from the one or more set of nodes. Each node in the first set has a reputation value which is higher than the reputation value of each node in other sets. The engagement module configured in the routing server determines a predicted action to be performed by each node in the first set. Each node in the first set performs an action. The routing server receives data from each node of the first set, wherein the data is associated with the action being performed by each node in the first set. Upon receiving the data, the routing server determines the delta value between the predicted action and the action performed by each node in the first set. Thereafter, the routing server updates the reputation value associated with each node based on the delta value determined for each node.

Henceforth, embodiments of the present disclosure are explained with the help of exemplary diagrams and one or more examples. However, such exemplary diagrams and examples are provided for the illustration purpose for better understanding of the present disclosure and should not be construed as limitation on scope of the present disclosure.

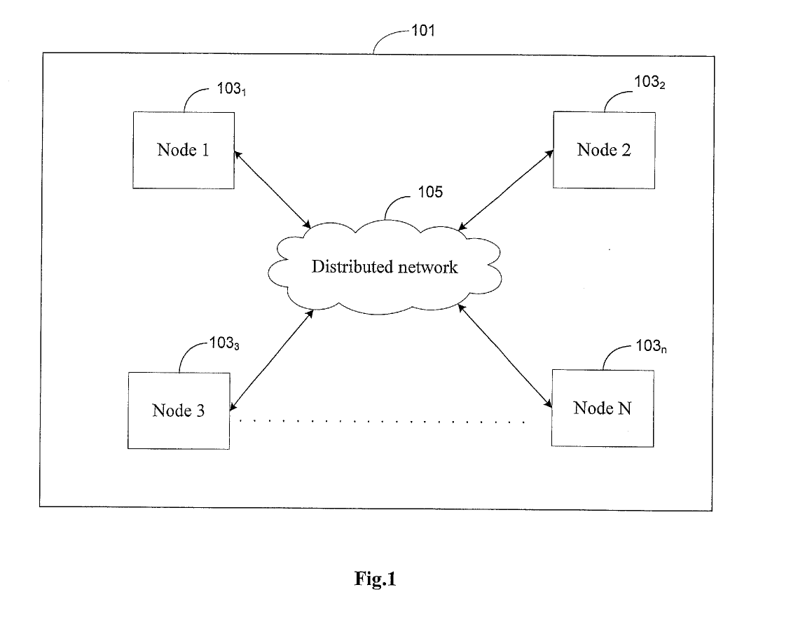

FIG. 1 illustrates an exemplary environment 101 for transmitting information on a priority basis to one or more nodes in the distributed network in accordance with some embodiments of the present disclosure. The environment 101 includes plurality of nodes, from node 1 103₁ to node n 103ₙ (collectively referred as plurality of nodes 103) connected through a distributed network 105. The distributed network 105 may include, but not limited to, Internet, relationships in a social network, entries in an address book, and wireless sensor networks. The plurality of nodes 103 can include hosts such as personal computers, phones, servers, any other networking hardware device, individuals in a social network, and entries in an address book. The host node 103 in the distributed network 105 may be associated with a routing server (not explicitly shown in FIG. 1). The routing server is associated with a processing unit and a memory (not explicitly shown in FIG. 1).

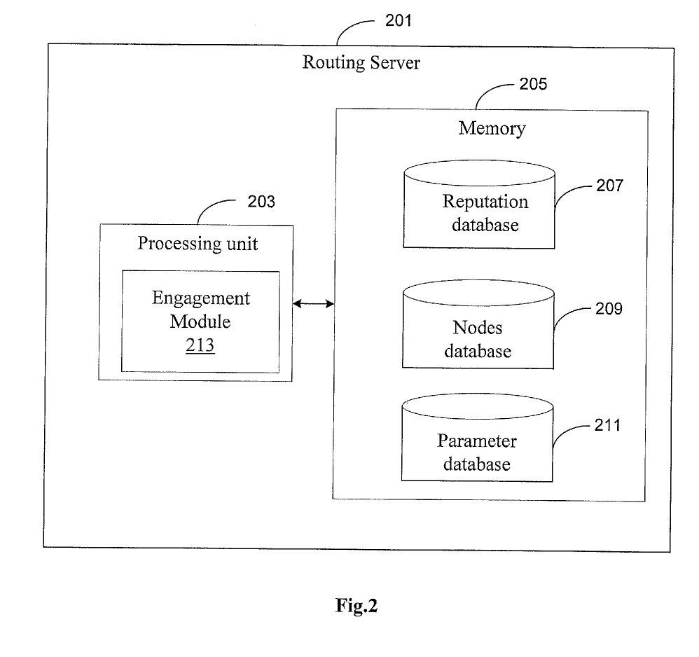

FIG. 2 illustrates a block diagram of a routing server 201 in accordance with some embodiments of the present disclosure. The routing server 201 comprises a processing unit 203 and a memory 205. The memory 205 includes at least one of a reputation database 207, nodes database 209 and a parameter database 211. The processing unit 203 includes an engagement module 213. The engagement module defines the universal set of all actions that can be performed by each node 103 in the distributed network 105 (also referred as network). The routing server 201 offers information resources to other nodes 103 in the network 105. The information may be, but not limited to, information related to job openings, information related to investment opportunities, information related to buying and selling goods. The routing server 201 extracts one or more parameters associated with the information and stores the one or more parameters in the parameter database 211. The routing server 201 identifies one or more nodes in the network 105 based on the information. Each node in the network 105 is associated with a reputation value. The reputation value is a predetermined value assigned to each node in the network based on its action performed for a given request/information. Based on the reputation value associated with each node the routing server 201 generates one or more set of nodes from a plurality of nodes in the network 105. The one or more set of nodes may be defined as a first set of nodes, a second set of nodes and so on. The nodes in the first set have a reputation value which is higher than the reputation value of the nodes in next set such as second set, third set and so on.

Since, the nodes in the first set have reputation value higher than the reputation value of nodes in the other set, the information from the source node is first provided to the nodes in the first set. Upon receiving the information, each node in the first set extracts one or more parameters associated with the information. The routing server 201 assigns a parameter value for each parameter. Say for example there are three parameters namely P1, P2 and P3 associated with the information. Let the parameter value assigned for P1 is 10. Similarly, let the parameter value assigned for P2 is 20 and for P3 is 30. Each node performs an action upon receiving the information based on one or more parameters. If the action performed by the node is based on P1 and P2 then the reputation value of the node is obtained by computing weighted sum of parameter value of each of the one or more parameters based operation i.e the reputation value of the node shall be weighted sum of P1 and P2, let it be 50. The routing server 201 receives data associated with the action performed by each node. Upon receiving the data, the routing server 201 determines a delta value between the predicted action and the action performed by each node in the first set. Thereafter, the routing server 201 updates the reputation value associated with each node in the first set based on the delta value determined for each node in the first set.

In some embodiments, the routing server 201 identifies the second set of one or more nodes and transmits the information to each node in the second set. The reputation value of each node in the second set is less than the reputation value of each node in the first set. Upon receiving the information, each node extracts the one or more parameters associated with the information. Each node in the second set performs an action based on one or more parameters. The routing server 201 receives the data associated with the action performed by each node of the second set. Upon receiving the data, the routing server 201 determines the delta value between the predicted action and the action performed by each node of the second set. Thereafter, the routing server 201 updates the reputation value of each node in the second set based on the delta value.

The routing server 201 identifies the next set of nodes and gives access to the information to the next set of nodes. This process continues till all the nodes have access to information or until the source node requests the routing server to stop further dissemination of the information.

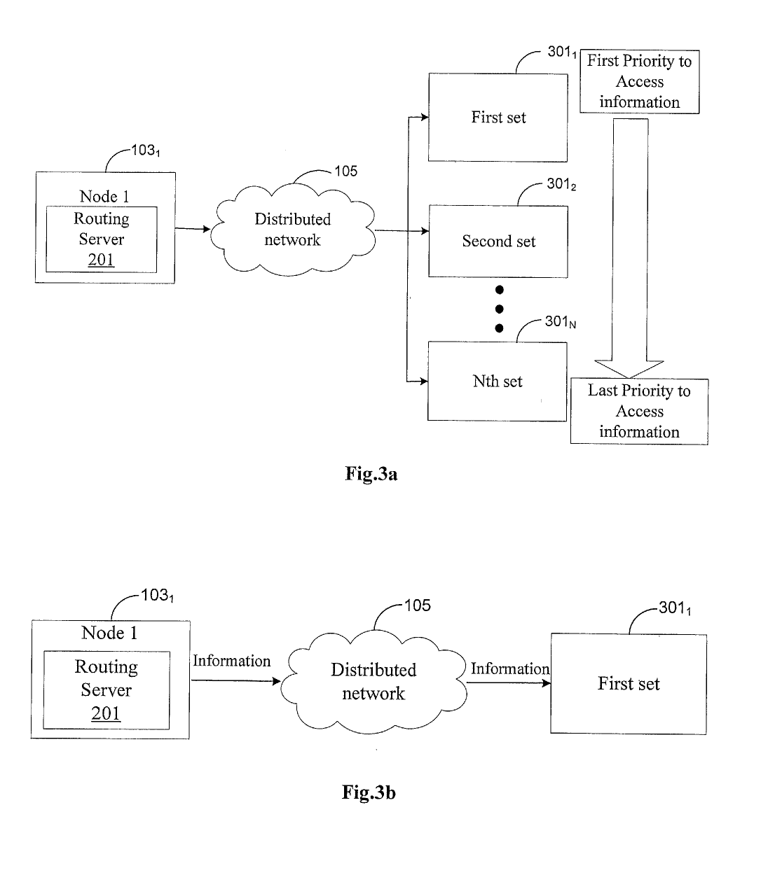

FIGS. 3a-3b illustrates an exemplary process for transmitting information on priority basis to one or more nodes in the network 105, in accordance with an embodiment of the present disclosure. As an example, let Node 1 103₁ the source node. The Node 1 103₁ offers information about a job opening. The routing server 201 at the Node 1 103₁ extracts one or more parameters associated with the information. The one or more parameters may be, but not limited to, skill set defined for a given job requirement (P1), description about ideal candidates (P2), profile of the company (P3), job description (P4) and the experience required for the given job opening (P5). The routing server 201 identifies a set of nodes with highest priority from a plurality of set of nodes in the network 105 which is capable of responding to the information. Each node in the network 105 is associated with a reputation value. The reputation value is a predetermined value assigned to each node in the network 105 based on past actions performed by each node for a given request/information. Based on the reputation value associated with each node the routing server 201 generates one or more set of nodes from a plurality of nodes in the network 105. The one or more set of nodes may be defined as a first set of nodes 301₁, a second set of nodes 301₂ and so on. As an example, the first set 301₁ may have the Node 2, Node 3 and Node 4. The second set 301₂ may have Node 5, Node 6 and Node 7 and third set may have Node 8, Node 9 and Node 10 and so on. The nodes in the first set 301₁ have high reputation value when compared with the reputation value of other nodes in other sets. The reputation value of Node 2, Node 3 and Node 4 of the first set is 100 each. The reputation value of Node 5, Node 6 and Node 7 of the second set is 90 each and the reputation of Node 8, Node 9 and Node 10 of the third set is 80 each and so on.

In some embodiments, the source node transmits information to the first set of nodes 301₁ on priority basis. The engagement module 213 in the routing server 201 determines the action to be performed by each node in the network which is referred as the predicted action. Each of the first set of nodes 301₄ performs an action referred as actual action. The source node receives data from each of the first set of nodes, based on the actual actions being performed. The routing server performs predefined computation to find a delta score between the predicted action and the actual action performed by the nodes. The routing server updates, in a reputation database configured in the routing server, the updated reputation value associated with each of the nodes in the first set 301₁ based on the computed delta score received data for each node.

Initially, the routing server 201 determines that the first set 301₁ has high priority to get access to the information when compared with the other sets. The second set 301₂ gets next priority to access the information from the source node and the Nth set gets the last priority to access the information, Accordingly, the routing server 201 transmits the information to each node in the first set 301₁ i.e Node 2, Node 3 and Node 4 receives information from the source node, Node 1. Upon receiving the information each node in the first set 301₁ extracts the parameters P1-P5 associated with the information. Upon extracting the parameters, each node performs an action based on the extracted parameters. The action performed by each node may be, but not limited to, sharing the information to at least one node, defining one or more characteristics for the information, responding to the information received from the routing server 201 and rejecting the information.

In an example embodiment, let Node 2 may perform an action A2 based on parameters P1 and P2. Similarly, Node 3 may perform an action A3 based on parameters P3 and P4 and Node 4 may perform an action AS based on parameter P5. Each parameter is associated with a parameter value and each action is associated with an action value. The parameter value assigned for P1 is 5, the parameter value assigned for P2 is 10, parameter value assigned for P3 is 15, the parameter value assigned for P4 is 20 and the parameter value assigned for P5 is 25. The action value assigned for A2, A2, A3 is 10 and action value assigned for A4, A5 is (−5). In an embodiment, the reputation value is determined by computing a weighted sum of parameter value of each parameter based action performed by each node.

The action performed by Node 2 is A2 based on the parameters P1 and P2. Therefore, the reputation value is the weighted sum of (A2, P1) and (A2, P2). Similarly, the action performed by Node 3 is A3, based on the parameters P3 and P4. Therefore, the reputation value is the weighted sum of (A3, P3) and (A3, P4). The action performed by Node 4 is A4 based on the parameter P5. Therefore, the reputation value is the weighted sum of (A4, P5). The routing server 201 receives data associated with the action performed by each node in the first set. Upon receiving the data, the routing server 201 determines delta value between the predicted action and the actual action performed by each node. The predicted action for Node 2 may be A2. The actual action performed by the Node 2 is A2. As the predicted action and actual action are same (or better in effect) the reputation value associated with Node 2 is increased. In another instance, the predicted action for Node 2 may be A2. The actual action performed by the Node 2 is A1. As the predicted action and actual action are different (or lower in effect) the reputation value associated with Node 2 is reduced. The routing server 201 updates the reputation value for Node 2 in the reputation database 207. In one embodiment, the routing server 201 updates the reputation value based on the delta reputation value computed on Node 2 between predicted action and action performed. In another embodiment, the routing server 201 updates the reputation value based on a configured value. Similarly, the routing server 201 updates the reputation value for Node 3 and Node 4 based on the action performed by Node 3 and Node 4. For every action performed by each node, the reputation value may go up or down. The delta value calculated by the routing server may increase or decrease the reputation value associated with each of the first set of nodes.

The routing server 201 may then transmit the information to the second set 301₂ i.e the second set 301₂ gets the second priority to access the job information.

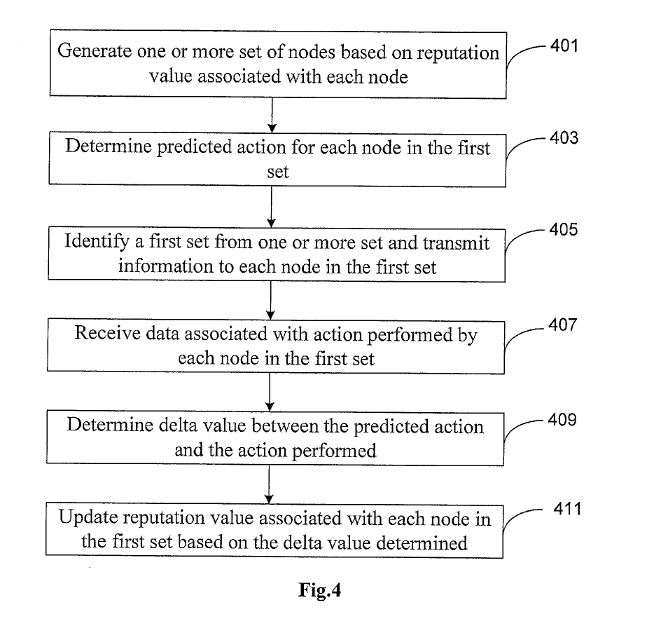

FIG. 4 shows a flowchart illustrating method for transmitting information on priority basis to one or more nodes in the network in accordance with some embodiments of the present disclosure. At step 401, the routing server 201 generates one or more set of nodes based on the reputation value associated with each node in the network 105. The reputation value is a predetermined value assigned for each node based on the participation of the node for given information. At step 403, the routing server 201 determines predicted action for each node in the network. At step 405, the routing server 201 identifies a first set from the one or more sets, wherein each node in the first set has a reputation value which is higher than the reputation value of the nodes in the other set. Upon identifying the first set, the routing server 201 transmits the information to each node in the first set. Upon receiving the information, each node of the first set extracts one or more parameters associated with the information. Thereafter, each node of the first set performs an action. At step 407, the routing server 201 receives the data associated with the action performed by each node of the first set. At step 409, the routing server 201 determines the delta value between the predicted action and the action performed by each node of the first set. At step 411, the routing server 201 updates the reputation value associated with each node of the first set based on the determined delta value. The routing server 201 then proceed to transmit the information to the second set and so on until the information reaches to all the nodes in the network or until the source node requests the routing server to stop further dissemination of the information.

The described operations may be implemented as a method, system or article of manufacture using standard programming and/or engineering techniques to produce software, firmware, hardware, or any combination thereof. The described operations may be implemented as code maintained in a “non-transitory computer readable medium”, where a processor may read and execute the code from the computer readable medium. The processor is at least one of a microprocessor or a processor capable of processing and executing the queries. The processor may be implemented as a central processing unit (CPU) for guided imaging unit 108. The CPU may include one or more processing units having one or more processor cores or having any number of processors having any number of processor cores. CPU may include any type of processing unit, such as, for example, a multi-processing unit, a reduced instruction set computer (RISC), a processor having a pipeline, a complex instruction set computer (CISC), digital signal processor (DSP), and so forth. A non-transitory computer readable medium may comprise media such as magnetic storage medium (e.g., hard disk drives, floppy disks, tape, etc.), optical storage (CD-ROMs, DVDs, optical disks, etc.), volatile and non-volatile memory devices (e.g., EEPROMs, ROMs, PROMs, RAMs, DRAMs, SRAMs, Flash Memory, firmware, programmable logic, etc.), etc. The non-transitory computer-readable media comprise all computer-readable media except for a transitory. The code implementing the described operations may further be implemented in hardware logic (e.g., an integrated circuit chip, Programmable Gate Array (PGA), Application Specific Integrated Circuit (ASIC), etc.).

Still further, the code implementing the described operations may be implemented in “transmission signals”, where transmission signals may propagate through space or through a transmission media, such as an optical fiber, copper wire, etc. The transmission signals in which the code or logic is encoded may further comprise a wireless signal, satellite transmission, radio waves, infrared signals, Bluetooth, etc. The transmission signals in which the code or logic is encoded is capable of being transmitted by a transmitting station and received by a receiving station, where the code or logic encoded in the transmission signal may be decoded and stored in hardware or a non-transitory computer readable medium at the receiving and transmitting stations or devices. An “article of manufacture” comprises non-transitory computer readable medium, hardware logic, and/or transmission signals in which code may be implemented. A device in which the code implementing the described embodiments of operations is encoded may comprise a computer readable medium or hardware logic. Of course, those skilled in the art will recognize that many modifications may be made to this configuration without departing from the scope of the invention, and that the article of manufacture may comprise suitable information bearing medium known in the art.

The terms “an embodiment”, “embodiment”, “embodiments”, “the embodiment”, “the embodiments”, “one or more embodiments”, “some embodiments”, and “one embodiment” mean “one or more (but not all) embodiments of the invention(s)” unless expressly specified otherwise.

The terms “including”, “comprising”, “having” and variations thereof mean “including but not limited to”, unless expressly specified otherwise. The enumerated listing of items does not imply that any or all of the items are mutually exclusive, unless expressly specified otherwise. Moreover, the terms “first,” “second,” “third,” and so forth, are used merely as labels, and are not intended to impose numerical requirements on their objects.

The terms “a”, “an” and “the” mean “one or more”, unless expressly specified otherwise. A description of an embodiment with several components in communication with each other does not imply that all such components are required. On the contrary a variety of optional components are described to illustrate the wide variety of possible embodiments of the invention.

When a single device or article is described herein, it will be readily apparent that more than one device/article (whether or not they cooperate) may be used in place of a single device/article. Similarly, where more than one device or article is described herein (whether or not they cooperate), it will be readily apparent that a single device/article may be used in place of the more than one device or article or a different number of devices/articles may be used instead of the shown number of devices or programs. The functionality and/or the features of a device may be alternatively embodied by one or more other devices which are not explicitly described as having such functionality/features. Thus, other embodiments of the invention need not include the device itself.

The illustrated operations of FIG. 4 show certain events occurring in a certain order. In alternative embodiments, certain operations may be performed in a different order, modified or removed. Moreover, steps may be added to the above described logic and still conform to the described embodiments. Further, operations described herein may occur sequentially or certain operations may be processed in parallel. Yet further, operations may be performed by a single processor or by distributed processing units.

Additionally, advantages of present disclosure are illustrated herein.

In an embodiment, the present disclosure provides a method for transmitting information on priority basis to one or more nodes in the network.

In an embodiment of the present disclosure, the method provides information to each node in the network based on the priority of each node in the network.

Finally, the language used in the specification has been principally selected for readability and instructional purposes, and it may not have been selected to delineate or circumscribe the inventive subject matter.

While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

### REFERRAL NUMERALS

| Reference Number | Description |
|---|---|
| 101 | Environment |
| 103 | Plurality of Nodes |
| 105 | Distributed Network |
| 201 | Routing server |
| 203 | Processing Unit |
| 205 | Memory |
| 207 | Influence Database |
| 209 | Nodes Database |
| 211 | Parameter Database |
| 213 | Engagement Module |

We claim:

1. A method for transmitting information on priority basis to one or more nodes in a distributed network, the method comprising:
a) generating, at a routing server, one or more set of nodes from a plurality of nodes in the distributed network based on a reputation value associated with each of the one or more nodes;
b) identifying a first set of nodes from the one or more set of nodes, wherein each node in the first set has a reputation value which is higher than the reputation value of each node in other sets;
c) determining, a predicted action to be performed by each node in the first set and transmitting information on a priority basis to each node in the first set;
d) receiving data from each node of the first set, wherein the data is associated with an action performed by each node in the first set;
e) determining a delta value between the predicted action and the action performed by each node in the first set; and
f) updating, in a reputation database configured in the routing server, the reputation value associated with each node in the first set based on the delta value determined for each node.

2. The method as claimed in claim 1, wherein the action performed by each node is one of sharing the information to at least one node, defining one or more characteristics for the information and responding to the information received from the routing server.

3. The method as claimed in claim 1 further comprising identifying next set of nodes other than the first set of nodes and repeating the steps from c) to f) of claim 1.

4. The method as claimed in claim 3, wherein each node in the next set of nodes is having a reputation value which is lower than the reputation value associated with each node in the first set.

5. The method as claimed in claim 1, wherein the reputation value associated with each node is increased by a value if the action performed by each node is same as the predicted action determined by the routing server.

6. The method as claimed in claim 1, wherein the reputation value associated with each node is decreased by a value if the action performed by each node is different from the predicted action determined by the routing server.

7. The method as claimed in claim 1, wherein each node obtains one or more parameters from the received information for performing the operation.

8. A routing server, comprising:
at least one processor; and
a memory storing instructions executable by the at least one processor, wherein the instructions configure the at least one processor to:
a. generate one or more set of nodes from a plurality of nodes in the distributed network based on the reputation value associated with each of the one or more nodes;
b. identify a first set of nodes from the one or more set of nodes, wherein each node in the first set is having a reputation value higher than the reputation value of each node in other sets;
c. determine a predicted action to be performed by each node in the first set and transmitting information on a priority basis to each node in the first set which has reputation value which is higher than the reputation value of each node in the other set;
d. receive data from each node of the first set, wherein the data is associated with the action performed by each node in the first set;
e. determine the delta value between the predicted action and the action performed by each node in the first set; and
f. update the reputation value associated with each node based on the delta value determined for each node.

9. The routing server as claimed in claim 8, wherein the instructions further configure the at least one processor to identify next set of nodes other than the first set of nodes and repeating the steps from b) to f) of claim 8.

10. The routing server as claimed in claim 8, wherein the instructions further configure the at least one processor to increase the reputation value, associated with each node, by a value if the action performed by each node is same as the predicted action determined by the routing server.

11. The routing server as claimed in claim 8, wherein the instructions further configure the at least one processor to decrease the reputation value, associated with each node, by a value if the action performed by each node is different from the predicted action determined by the routing server,

12. The routing server as claimed in claim 8 transmits the information to the nodes with higher reputation value first before transmitting the information to the nodes with lower reputation value.
